(19) United States
(12) Patent Application Publication
(10) Pub. No.: US 2025/0071672 A1
(43) Pub. Date: Feb. 27, 2025

(54) SYSTEM AND METHOD FOR PERFORMING SLICE-BASED CELL RESELECTION IN A WIRELESS COMMUNICATION SYSTEM

(71) Applicant: SAMSUNG ELECTRONICS CO., LTD., Suwon-si, Gyeonggi-do (KR)

(72) Inventor: Aby KANNEATH ABRAHAM, Bangalore (IN)

(21) Appl. No.: 18/727,046

(22) PCT Filed: Jan. 9, 2023
(86) PCT No.: PCT/KR2023/000395

§ 371 Date: Jul. 5, 2024

(30) Foreign Application Priority Data
Jan. 7, 2022 (IN) 202241001027
Dec. 27, 2022 (IN) 202241001027

(51) Int. Cl. H04W 48/18; H04W 48/08

(52) U.S. Cl. CPC H04W 48/18; H04W 48/08

(57) ABSTRACT

The disclosure relates to a 5G or 6G communication system for supporting a higher data transmission rate. The present subject matter refers to a system and a method for performing slice-based cell reselection. The method includes receiving (802) a slice priority by a UE (100) from a network for each of one or more groups of slices over a NAS. Further, the method includes receiving (804) a frequency priority information and receiving (806) a set of legacy cell reselection priorities un-associated with the one or more slices by the UE (100) from the network for each of the one or more groups of slices from the network 804 one or more groups of slices Furthermore, the method includes determining (808) a relative priority by the UE (100) for each of the set of frequencies based on the received slice priority and the received frequency priority information by using one or more conditions. The method also includes performing (810) slice-based cell reselection by the UE (100) based on the determined relative priority.

### TECHNICAL FIELD

The disclosure relates to wireless communication (or, a mobile communication system). More particularly, the disclosure relates to a system and method for performing slice-based cell reselection in a wireless communication system (or a mobile communication system).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

There are needs to enhance procedures of performing slice-based cell reselection.

### Solution to Problem

According to an embodiment of the disclosure, a method performed by a user equipment (UE) is provided. The method comprises obtaining first information including a slice priority for at least one group of slices, wherein the at least one group of slices includes at least one slice; receiving, from a base station, second information including a group cell reselection priority for each of the at least one group of slices, wherein the group cell reselection priority associated with a priority of at least one group frequency that supports each of the at least one group of slices; receiving, from the base station, third information including a cell reselection priority for at least one frequency that supports none of the at least one group; identifying the reselection priority for the at least one group of slices and the at least one frequency based on the first information, the second information, and the third information; and performing slice-based cell reselection based on the identified priority.

According to an embodiment of the disclosure, a user equipment (UE) is provided. The UE comprises a transceiver; and at least one processor coupled with the transceiver and configured to: obtain first information including a slice priority for at least one group of slices, wherein the at least one group of slices includes at least one slice, receive, from a base station, second information including a group cell reselection priority for each of the at least one group of slices, wherein the group cell reselection priority associated with a priority of at least one group frequency that supports each of the at least one group of slices, receive, from the base station, third information including a cell reselection priority for at least one frequency that supports none of the at least one group, identify the reselection priority for the at least one group of slices and the at least one frequency based on the first information, the second information, and the third information, and perform slice-based cell reselection based on the identified priority.

### Advantageous Effects of Invention

According to various embodiments of the disclosure, procedures regarding performing slice-based cell reselection can be efficiently enhanced.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a diagram illustrating a User Equipment (UE) for performing slice-based cell reselection, according to an embodiment of the present disclosure;

FIG. 2 illustrates a flow diagram depicting a prioritization of a frequency A and a frequency B with slices, according to an embodiment of the present disclosure;

FIG. 3 illustrates a flow diagram depicting for performing slice-based cell reselection based on a slice priority of a cell, according to an embodiment of the present disclosure;

FIG. 4 illustrates a flow diagram depicting a slice-based priority implementation with a priority matrix, according to an embodiment of the present disclosure;

FIG. 5 illustrates a flow diagram depicting a slice-based priority implementation with the priority matrix, according to an embodiment of the present disclosure;

FIG. 6 illustrates a flow diagram depicting a prioritization of two frequencies with slices and services, according to an embodiment of the present disclosure;

FIG. 7 illustrates a flow diagram for repeating the slice-based cell reselection based on slice update information and frequency update information, according to an embodiment of the present disclosure;

FIG. 8 illustrates a flow diagram depicting a method for performing the slice-based cell reselection, according to an embodiment of the present disclosure; and

FIG. 9 illustrates a flow diagram depicting a method for performing the slice-based cell reselection, according to another embodiment of the present disclosure.

FIG. 10 illustrates a block diagram of a base station according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### BEST MODE FOR CARRYING OUT THE INVENTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illu-minating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

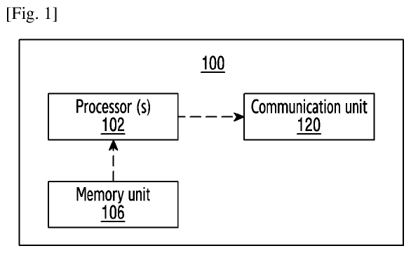

FIG. 1 is a diagram illustrating a User Equipment (UE) 100 for performing slice-based cell reselection, according to an embodiment of the present disclosure. The configuration of FIG. 1 may be understood as a part of the configuration of the UE 100. Hereinafter, it is understood that terms including “unit” or “module” at the end may refer to the unit for processing at least one function or operation and may be implemented in hardware, software, or a combination of hardware and software.

Referring to FIG. 1, the UE 100 may include one or more processors 102, a communication unit 104 (e.g., communicator or communication interface), and a memory unit 106 (e.g., storage). By way of example, the UE 100 may be a User Equipment, such as a cellular phone or other devices that communicate over a plurality of cellular networks (such as a 3G, 4G, a 5G or pre-5G, 6G network or any future wireless communication network). The communication unit 104 may perform functions for transmitting and receiving signals via a wireless channel.

As an example, the one or more processors 102 may be a single processing unit or a number of units, all of which could include multiple computing units. The one or more processors 102 may be implemented as one or more microprocessors, microcomputers, microcontrollers, digital signal processors, central processing units, state machines, logic circuitries, and/or any devices that manipulate signals based on operational instructions. Among other capabilities, the one or more processors 102 are configured to fetch and execute computer-readable instructions and data stored in the memory. The one or more processors 102 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors may control the processing of the input data in ac-cordance with a predefined operating rule or artificial intelligence (AI) model stored in the non-volatile memory and the volatile memory, i.e., memory unit 106. The predefined operating rule or artificial intelligence model is provided through training or learning.

The memory unit 106 may include any non-transitory computer-readable medium known in the art including, for example, volatile memory, such as static Random-Access memory (SRAM) and dynamic random access memory (DRAM), and/or non-volatile memory, such as read-only memory (ROM), erasable programmable ROM, flash memories, hard disks, optical disks, and magnetic tapes.

Some example embodiments disclosed herein may be implemented using processing circuitry. For example, some example embodiments disclosed herein may be implemented using at least one software program running on at least one hardware device and performing network management functions to control the elements.

In an embodiment of the present disclosure, the one or more processors 102 of the UE 100 are configured to perform slice-based cell reselection. Cell reselection is a process that identifies a cell that the UE 100 is required to camp on when the UE 100 is in a non-connected state i.e., Radio Resource Control (RRC)_IDLE and RRC_INACTIVE. In an embodiment of the present disclosure, a cell is a geographical area covered by a frequency emitted by a base station in a cellular network. Further, the one or more processors 102 are configured to receive a slice priority from a network for each of one or more groups of slices over a Non-Access Stratum (NAS) or on internal configurations of the UE 100. In an embodiment of the present disclosure, each of the one or more groups of slices includes one or more slices. The slice priority represents the priority of each of the one or more groups of slices. In an embodiment of the present disclosure, a slice is equipment-vendor agnostic and may span across a radio network from vendor one, to a core from vendor two and the like. Furthermore, operators may define a set of characteristics of the slice, such as latency, speed, re-liability, security, and the like. In an embodiment of the present disclosure, the NAS is a functional layer running between the UE 100 and a core network.

Further, the one or more processors 102 receive frequency priority information for each of the one or more groups of slices from the network. In an exemplary embodiment of the present disclosure, the frequency priority information is received from a gNodeB. In an embodiment of the present disclosure, the frequency priority information includes a set of frequencies supported by each of the one or more groups of slices and a frequency priority of each of the set of frequencies. Further, the one or more processors 102 receive a set of legacy cell reselection priorities un-associated with the one or more groups of slices for the set of frequencies from the network. In an exemplary embodiment of the present disclosure, the set of legacy cell reselection priorities are received from the gNodeB.

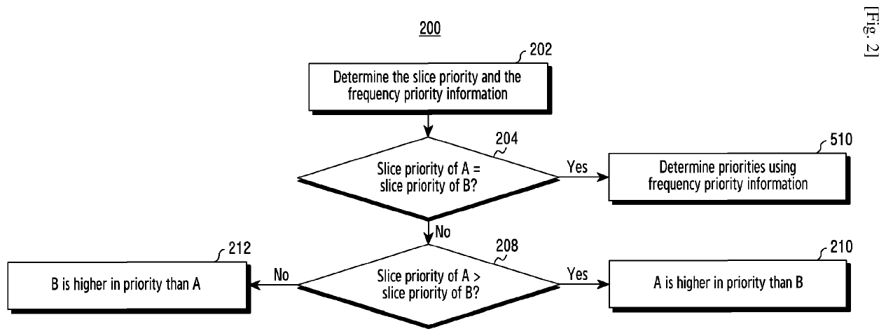

Furthermore, the one or more processors 102 determine a relative priority for each of the set of frequencies based on the received slice priority, the received frequency priority information, and the received set of legacy cell reselection priorities by using one or more conditions. Relative prioritization of the set of frequencies has been explained in further paragraphs by using an example with reference to steps 202 to 212 of FIG. 2 and steps 602 to 612 of FIG. 6. In an embodiment of the present disclosure, the one or more conditions define rules for the prioritization of the set of frequencies. Further, the one or more processors 102 perform slice-based cell reselection based on the determined relative priority.

In determining the relative priority for each of the set of frequencies based on the received slice priority, the received frequency priority information, and the received set of legacy cell reselection priorities by using the one or more conditions, the one or more processors 102 identifies one or more first frequencies from the set of frequencies supporting one or more highest priority slices based on the received slice priority. The one or more highest priority slices are slices from the one or more groups of slices with the highest slice priority as compared to the slice priority of other slices of among one or more groups of slices. Further, the one or more processors 102 prioritizes the identified one or more first frequencies over other frequencies of the set of frequencies supporting one or more lower-priority slices. In an embodiment of the present disclosure, the one or more lower priority slices are slices from the one or more groups of slices with lower slice priority as compared to the slice priority of other slices among the one or more groups of slices. Furthermore, the slice-based cell reselection is performed based on a result of prioritization.

Further, in determining the relative priority for each of the set of frequencies based on the received slice priority, the received frequency priority information, and the received set of legacy cell reselection priorities by using the one or more conditions, the one or more processors 102 identify one or more frequencies from the set of frequencies supporting a group of slices from the one or more groups of slices. In an embodiment of the present disclosure, the group of slices ranges from the highest priority to a lowest priority. The one or more processors 102 prioritizes each of the one or more frequencies supporting the group of slices including a group of slices having the highest priority based on the received frequency priority information or the frequency priority of each of the set of frequencies in ascending order. The slice-based cell reselection is performed based on a result of prioritization.

Furthermore, in determining the relative priority for each of the set of frequencies based on the received slice priority, the received frequency priority information, and the received set of legacy cell reselection priorities by using the one or more conditions, the one or more processors 102 determine if the received frequency priority information for a slice of the group of slices includes a frequency priority for a frequency from the one or more frequencies. The one or more processors 102 prioritize the one or more frequencies over the frequency upon determining that the received frequency priority information excludes the frequency priority for the frequency. In an embodiment of the present disclosure, the frequency has a lower priority as compared to the one or more frequencies having the frequency priority for the one or more groups of slices. The slice-based cell reselection is performed based on a result of prioritization. For example, if a frequency is not having a priority in the received frequency priority information for a given slice, the frequency is considered as the lowest priority frequency supporting the slice.

Further, in determining the relative priority for each of the set of frequencies based on the received slice priority, the received frequency priority information, and the received set of legacy cell reselection priorities by using the one or more conditions, the one or more processors 102 identify one or more second frequencies from the set of frequencies un-supporting all of the one or more slices supported by the UE 100. The one or more processors 102 prioritize one or more third frequencies from the set of frequencies supporting the one or more slices over the one or more second frequencies.

In an embodiment of the present disclosure, in determining the relative priority for each of the set of frequencies based on the received slice priority, the received frequency priority information, and the received set of legacy cell reselection priorities by using the one or more conditions, the one or more processors 102 assign the relative priority to each of the one or more second frequencies that are not supporting any of the one or more slices supported by the UE 100 based on an order of the received set of legacy cell reselection priorities. In an exemplary embodiment of the present disclosure, the set of legacy cell reselection priorities are provided in system information, a Radio Resource Control (RRC) Release message or inherited from another Radio Access Technology (RAT) at inter-RAT cell reselection.

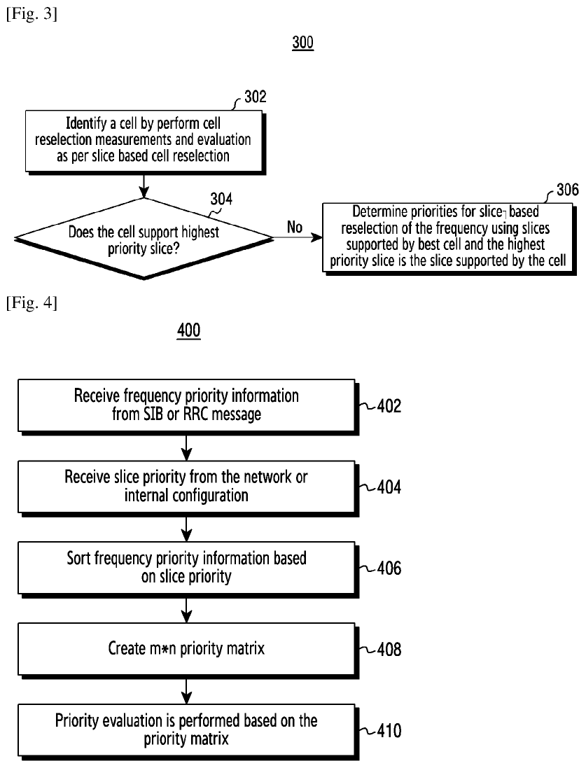

Further, in determining the relative priority for each of the set of frequencies based on the received slice priority, the received frequency priority information, and the received set of legacy cell reselection priorities by using the one or more conditions, the one or more processors 102 identify a cell in a frequency from the set of frequencies among one or more cells of in a frequency of the network by comparing Reference Signal Received Power (RSRP) or Reference Signal Received Quality (RSRQ) as configured by the network of each of the one or more cells in the frequency of the network. In an embodiment of the present disclosure, the RSRP is a measure of the received power level in a NR cell network. The RSRQ is used in 5G New Radio (NR) networks to determine the quality of a radio channel. The cell has the highest RSRP or highest RSRQ amongst the one or more cells in the frequency. Further, the one or more processors 102 determine if the cell in the frequency supports the one or more highest priority slices from the one or more groups of slices. Furthermore, the one or more processors 102 prioritize one or more fourth frequencies from the set of frequencies supporting one or more highest priority slices over the frequency upon determining that the cell in the frequency fails to support the one or more highest priority slices. In an embodiment of the present disclosure, the UE 100 ignores the one or more highest priority slices and considers no slice or the one or more first slices from the one or more groups of slices supported by the cell while performing the slice-based cell re-selection. The slice-based cell reselection is performed based on a result of prioritization. Thus, the UE 100 handles the case where the cell doesn't support the highest priority slice. For example, in a first frequency (F1), supported slices in the order of priority are a first slice (S1)>second slice (S2)>third slice (S3). In a second frequency (F2), supported slices in the order of priority is S2>S3. Further, the relative priority of F1>F2. Furthermore, a cell (C1) with the highest RSRP or RSRQ in F1 supports S3 and doesn't support S1, S2, and a cell (C2) with the highest RSRP or RSRQ in F2 supports S2. For relative priority determination, F1 uses S3 and F2 uses S2. The relative priority of F2>F1 after applying the best cell's priority. Details on performing the slice-based cell reselection based on the slice priority of the cell have been explained in further paragraphs with reference to steps 302 to 306 of FIG. 3.

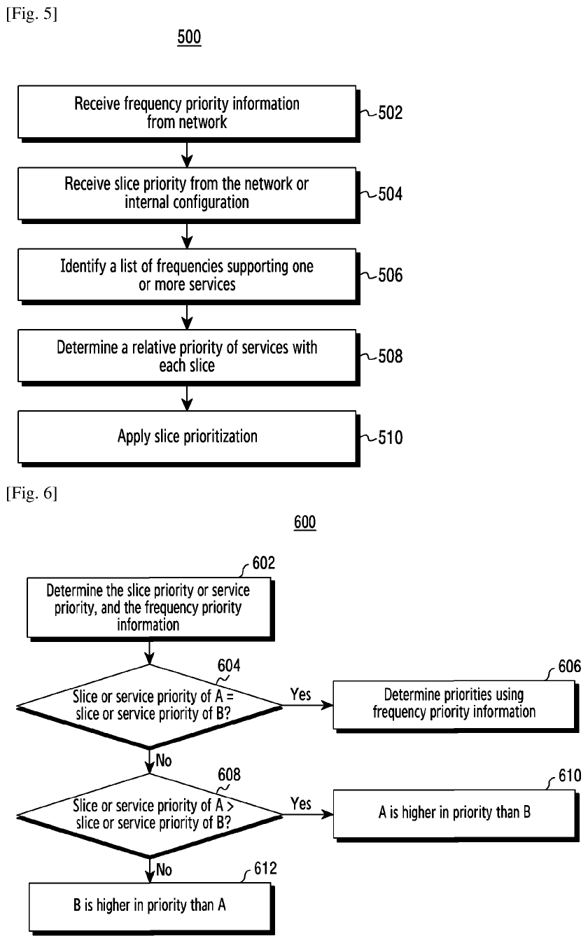

Furthermore, in determining the relative priority for each of the set of frequencies based on the received slice priority, the received frequency priority information, and the received set of legacy cell reselection priorities by using the one or more conditions, the one or more processors 102 identify one or more fifth frequencies from the set of frequencies supporting one or more services. In an exemplary embodiment of the present disclosure, the one or more services include Vehicle-to-everything (V2X), New Radio (NR)-sidelink, Multicast and Broadcast Services (MBS), and the like. The one or more processors 102 prioritize each of the identified one or more fifth frequencies over one or more third frequencies supporting the one or more slices. The slice-based cell reselection is performed based on a result of prioritization. Details on the one or more services have been explained in further paragraphs with reference to steps 502-510 of FIG. 5.

In performing the slice-based cell reselection based on the determined relative priority, the one or more processors 102 create a priority list or a priority matrix based on the determined relative priority for each of the set of frequencies. In an embodiment of the present disclosure, each row of the priority matrix corresponds to slice priorities of each of the one or more groups of slices and each column of the priority matrix represents an absolute priority value of the set of frequencies. Further, the one or more processors 102 perform the slice-based cell reselection based on the created priority list or the priority matrix. In an embodiment of the present disclosure, the UE 100 considers the highest priority frequency, a cell and one or more highest priority slices based on the created priority list or the priority matrix for performing the slice-based cell reselection. Further, details on the creation of the priority matrix have been explained in further paragraphs with reference to steps 402 to 410 of FIG. 4.

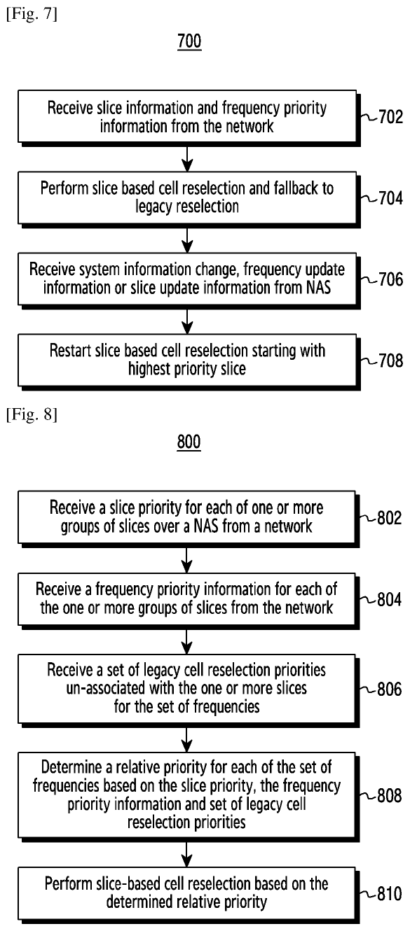

Further, the one or more processors 102 receive slice update information from the network over the NAS. The slice update information corresponds to a change in slice priority of the one or more groups of slices and dedicated slice priority timeout. Further, the one or more processors 102 receive frequency update information from the network. In an embodiment of the present disclosure, the frequency update information corresponds to a change in the set of frequencies supported by each of the one or more slices, the frequency priority of each of the set of frequencies or a combination thereof. Furthermore, the one or more processors 102 repeat the slice-based cell reselection based on the determined relative priority for each of the set of frequencies, the received slice updated information and the received frequency update information. Details on repeating the slice-based cell reselection have been explained in further paragraphs with reference to steps 702 to 708 of FIG. 7.

In another embodiment of the present disclosure, the one or more processors 102 of the UE 100 receive the slice priority from the network for each slice of one or more slices over the NAS. The one or more processors 102 receive the frequency priority information for each slice from the network. The frequency priority information includes a set of frequencies supported by each slice and a frequency priority of each of the set of frequencies. The one or more processors 102 receive the set of legacy cell reselection priorities un-associated with the one or more slices for the set of frequencies from the network. Further, the one or more processors 102 determine a relative priority for each of the set of frequencies based on the received slice priority, the received frequency priority information, and the received set of legacy cell reselection priorities by using one or more conditions. The one or more processors 102 perform slice-based cell reselection based on the determined relative priority.

In determining the relative priority for each of the set of frequencies based on the received slice priority, the received frequency priority information, and the received set of legacy cell reselection priorities by using the one or more conditions, the one or more processors 102 identify one or more first frequencies from the set of frequencies supporting the highest priority slice based on the received slice priority. In an embodiment of the present disclosure, the highest priority slice is a slice from the one or more slices with the highest slice priority as compared to the slice priority of other slices among the one or more slices. Further, the one or more processors 102 prioritize the identified one or more first frequencies over other frequencies of the set of frequencies supporting one or more lower-priority slices. In an embodiment of the present disclosure, the one or more lower priority slices are slices from the one or more slices with lower slice priority as compared to the slice priority of other slices among the one or more slices. The slice-based cell reselection is performed based on a result of prioritization.

Further, in determining the relative priority for each of the set of frequencies based on the received slice priority, the received frequency priority information, and the received set of legacy cell reselection priorities by using the one or more conditions, the one or more processors 102 identify one or more frequencies from the set of frequencies supporting a slice from the one or more slices. In an embodiment of the present disclosure, the slice ranges from the highest priority to the lowest priority. The one or more processors 102 prioritize each of the one or more frequencies supporting the slice based on the received frequency priority information or the frequency priority of each of the set of frequencies in ascending order. The slice-based cell reselection is performed based on a result of prioritization.

Furthermore, in determining the relative priority for each of the set of frequencies based on the received slice priority, the received frequency priority information, and the received set of legacy cell reselection priorities by using the one or more conditions, the one or more processors 102 determine if the received frequency priority information for the slice includes a frequency priority for a frequency from the one or more frequencies. The one or more processors 102 prioritize the one or more frequencies over the frequency upon determining that the received frequency priority information excludes the frequency priority for the frequency. In an embodiment of the present disclosure, the frequency has a lower priority as compared to the one or more frequencies having the frequency priority for the slice. The slice-based cell reselection is performed based on a result of prioritization.

In determining the relative priority for each of the set of frequencies based on the received slice priority, the received frequency priority information, and the received set of legacy cell reselection priorities by using the one or more conditions, the one or more processors 102 identify one or more second frequencies from the set of frequencies un-supporting all of the one or more slices supported by the UE 100. Further, the one or more processors 102 prioritize one or more third frequencies from the set of frequencies supporting the one or more slices over the one or more second frequencies.

In determining the relative priority for each of the set of frequencies based on the received slice priority, the received frequency priority information, and the received set of legacy cell reselection priorities by using the one or more conditions, the one or more processors 102 assign the relative priority to each of the one or more second frequencies that are not supporting any of the one or more slices supported by the UE 100 based on an order of the received set of legacy cell reselection priorities.

In determining the relative priority for each of the set of frequencies based on the received slice priority, the received frequency priority information, and the received set of legacy cell reselection priorities by using the one or more conditions, the one or more processors 102 identify a cell in a frequency from the set of frequencies among one or more cells in a frequency of the network by comparing RSRP or RSRQ as configured by the network of each of the one or more cells in the frequency of the network. The cell has the highest RSRP or highest RSRQ amongst the one or more cells in the frequency. Further, the one or more processors 102 determine if the cell in the frequency supports the highest priority slice from the one or more slices. The one or more processors 102 prioritize one or more fourth frequencies from the set of frequencies supporting one or more highest priority slices over the frequency upon determining that the cell in the frequency fails to support the highest priority slice. In an embodiment of the present disclosure, the UE 100 ignores the highest priority slice and considers no slice or the one or more first slices from the one or more slices supported by the cell while performing the slice-based cell reselection. The slice-based cell reselection is performed based on a result of prioritization.

In determining the relative priority for each of the set of frequencies based on the received slice priority, the received frequency priority information, and the received set of legacy cell reselection priorities by using the one or more conditions, the one or more processors 102 identify one or more fifth frequencies from the set of frequencies supporting the one or more services. Further, the one or more processors 102 prioritize each of the identified one or more fifth frequencies over one or more third frequencies supporting the one or more slices. The slice-based cell reselection is performed based on a result of prioritization.

In performing the slice-based cell reselection based on the determined relative priority, the one or more processors 102 create the priority list, or the priority matrix based on the determined relative priority for each of the set of frequencies. Further, the one or more processors 102 perform the slice-based cell reselection based on the created priority list and the priority matrix. In an embodiment of the present disclosure, the UE 100 considers the highest priority frequency, a cell and the highest priority slice based on the created priority list or the priority matrix for performing the slice-based cell reselection.

In an embodiment of the present disclosure, the one or more processors 102 receive slice update information from the network over the NAS. The slice update information corresponds to a change in the slice priority of the one or more slices and dedicated slice priority timeout. Further, the one or more processors 102 receive frequency update information from the network. The frequency update information corresponds to a change in the set of frequencies supported by each of the one or more slices, the frequency priority of each of the set of frequencies or a combination thereof. Furthermore, the one or more processors 102 repeat the slice-based cell reselection based on the determined relative priority for each of the set of frequencies, the received slice updated information and the received frequency update information.

FIG. 2 illustrates a flow diagram 200 depicting a prioritization of a frequency A and a frequency B with slices, according to an embodiment of the present disclosure. As depicted, a process for determining relative priority of the frequency A and the frequency B is determined by performing a first set of steps.

At step 202, the slice priority for each of the one or more groups of slices is determined. Further, at step 202, the frequency priority information for each of the one or more groups of slices is also determined. In another embodiment of the present disclosure, the slice priority, and the frequency priority information for each of the one or more slices is determined at step 202. Further, slice priority in a frequency is equal to a priority of the highest priority group of slices for the frequency A or 0 if the frequency A is not in the frequency priority information of any slice. In an exemplary embodiment of the present disclosure, the frequency priority information includes the set of frequencies supported by each of the one or more groups of slices and the frequency priority of each of the set of frequencies. Furthermore, the frequency priority is equal to a frequency priority from the frequency priority information of the highest priority group of slices or 0 if there is no frequency priority for the highest priority group of slices or legacy priority if the frequency is not in the frequency priority information of any slice.

At step 204, it is determined if the slice priority of the frequency A is equal to the slice priority of the frequency B. If the slice priority of the frequency A is equal to the slice priority of the frequency B, step 206 is performed. Further, if the slice priority of the frequency A is not equal to the slice priority of the frequency B, step 208 is performed.

At step 206, priorities of the frequencies A and B are determined based on the frequency priority information. The priority of the frequency A is higher than the priority of the frequency B if the frequency priority of the frequency A is higher than the frequency priority of the frequency B. Further, the priority of the frequency A is equal to the priority of the frequency B if the frequency priority of the frequency A is equal to the frequency priority of the frequency B. Furthermore, the priority of the frequency A is lower than the priority of the frequency B if the frequency priority of the frequency A is lower than the frequency priority of the frequency B.

At step 208, it is determined if the slice priority of the frequency A is higher than the slice priority of the frequency B. If the slice priority of the frequency A is higher than the slice priority of the frequency B, step 210 is performed. Further, if the slice priority of the frequency A is lower than the slice priority of the frequency B, step 212 is performed.

At step 210, it is determined that the frequency A is higher in priority than the frequency B.

At step 212, it is determined that the frequency B is higher in priority than the frequency A.

FIG. 3 illustrates a flow diagram 300 depicting for performing slice-based cell reselection based on a slice priority of a cell, according to an embodiment of the present disclosure. At step 302, a cell is identified in a frequency from the set of frequencies among the one or more cells in a frequency of the network by performing cell reselection measurements and evaluation as per slice-based cell reselection. In performing the cell reselection measurements and evaluation as per slice-based cell reselection, the RSRP or the RSRQ as configured by the network of each of the one or more cells in the frequency of the network are compared. In an exemplary embodiment of the present disclosure, the cell has one of the highest RSRP and highest RSRQ amongst the one or more cells in the frequency.

At step 304, it is determined if the cell in the frequency supports the highest priority slice from the one or more slices. If the cell in the frequency does not support the highest priority slice from the one or more slices, step 306 is performed.

At step 306, priorities are determined for the slice-based reselection of the frequency using slices supported by the cell and the highest priority slice is the slice supported by the cell.

FIG. 4 illustrates a flow diagram 400 depicting a slice-based priority implementation with a priority matrix, according to an embodiment of the present disclosure. In an embodiment of the present disclosure, the UE 100 represents slice priorities, relative priorities, and sub-priorities (if any) by using the priority matrix. In an embodiment of the present disclosure, each row corresponds to slice priorities of each of the one or more groups of slices and each column represents an absolute priority value of the set of frequencies. In another embodiment of the present disclosure, each row corresponds to slice priorities of the one or more slices and each column represents the absolute priority value of the set of frequencies. Further, a first slice or a first group of slices with the highest priority may be at a first row of the priority matrix, a second slice or a second group of slices with the second highest priority may be at a second row of the priority matrix, a third slice or a third group of slices with the third highest priority may be at a third row of the priority matrix, and the like. In an exemplary implementation of the priority matrix, slice priorities are defined in a descending order i.e., a priority value 1 is the highest priority and value 8 is the lowest priority. Further, the last row of the priority matrix is for legacy priorities i.e., for frequencies not supporting any slice. In an embodiment of the present disclosure, each element of the priority matrix is a frequency or a list of frequencies with equal priorities. In an embodiment of the present disclosure, frequency priorities are defined in ascending order. In an exemplary implementation of the priority matrix, a first column is assigned a special priority value 1 for the frequencies without a frequency priority for the slice or the group of slices. Further, priority 1 is the lowest frequency priority value and is in a second column of the priority matrix, and priority 8 is the highest priority and is in a last column of the priority matrix. The priority matrix may be referred to as CellRese-lectionPrio matrix. In an embodiment of the present disclosure, priority for a frequency, F is equal to CellReselectionPriom,n where m is the highest priority slice for F and n is the priority in frequency priority information of m for F. CellReselec-tionPriom,n is greater than CellReselectionPrioa,b when m is greater than a or m is equal to a and n is greater than b. Further, “m is greater than a” means that the slice priority value (defined in descending order) associated with “m is greater than a” and “n is greater than b” means the frequency priority value (defined in descending order) associated with n is greater than b. Further, CellReselectionPriom,n is equal to CellRe-selectionPrioa,b when m is equal to a and n is equal to b. In an embodiment of the present disclosure, the condition “m is greater than a” ensures that frequencies supporting higher-priority slices are having higher relative priority. The condition “n is greater than b when m is equal to a” ensures that for the frequencies which support slices with the same highest priority, relative prioritization is performed as per the frequency priority for their highest priority slice. As the legacy priorities are added in the bottom most row, any frequency which doesn't support the UE's slices may have a lower relative priority than the frequencies which support any of the UE's slices due to the condition “m is greater than a”. The frequencies which don't support the UE's slices are ordered according to the legacy priorities since the condition when m is equal to a and n is equal to b applies to the bottom row as well.

In an exemplary scenario of three slices with multiple supporting frequencies, consider that Slice 1 has the highest priority, Slice 2 has the second highest priority, and Slice 3 has the third highest priority with frequency priorities. For example, consider that Slice 1 has a frequency priority for F1 equal to 8, the frequency priority for F2 equal to 5, and the frequency priority for F3 equal to 1 as the frequency priorities for the multiple supporting frequencies. Further, consider that Slice 2 has as the frequency priority for F1 equal to 8, the frequency priority for F4 equal to 5, and the frequency priority for F5 equal to 5 as the multiple supporting frequencies. Furthermore, Slice 3 has the frequency priority for F6 equal to 6, the frequency priority for F7 equal to 5, and the frequency priority for F8 equal to 2. Furthermore, consider legacy priority As F1 equal to 4, F2 equal to 3, F3 equal to 5, F4 equal to 8, F5 equal to 4, F6 equal to 3, F7 equal to 5, F8 equal to 1, and F9 equal to 8. The priorities for the current scenario may be represented as per the below priority matrix:

| | | | | | | | |
|---|---|---|---|---|---|---|---|
| Prio1 | Prio2 | Prio3 | Prio4 | Prio5 | Prio6 | Prio7 | Prio8 |

| | | | | | | | |
|---|---|---|---|---|---|---|---|
| Slice1 | F3 | | | | F2 | | F1 |
| Slice2 | | | | | {F4, | | F1 |
| | | | | | F5} | | |
| Slice3 | | F8 | | | F7 | F6 | |
| Legacy | F8 | | {F2, | {F1, | {F3, | | {F4, |
| | | | F6} | F5} | F7} | | F9} |

For example, in a case where the UE 100 is camped on a cell in F4. F4 is present in two cells in the priority matrix i.e., in cell (row=2, column=5) and cell (row=4, column=8). Further, the priority for serving frequency is CellReselectionPrio2,5 as slice 2 is the highest priority slice. Based on the above priority rules CellReselec-tionPriom,n is more than CellReselectionPrioa,b when m is greater than a or m is equal to a and n is greater than b. Further, CellReselectionPriom,n is equal to CellReselec-tionPrioa,b when m is equal to a and n is equal to b. It may be derived that F1 (priority to be considered based on the row of highest priority slice supported in the frequency, slice 1 i.e. CellReselectionPrio1, 8), F2 (priority to be considered based on the row of highest priority slice supported in the frequency, slice 1 i.e. CellReselectionPrio1, 5), F3 (priority to be considered based on the row of highest priority slice supported in the frequency, slice 1 i.e. CellReselectionPrio1,1) are higher priority than F4. F5 (priority to be considered based on the row of highest priority slice supported in the frequency, slice 2 i.e. CellReselectionPrio2,5) is equal priority to F4 and F6 (priority to be considered based on the row of highest priority slice supported in the frequency, slice 3 i.e. CellReselectionPrio3,6), F7 (priority to be considered based on the row of highest priority slice supported in the frequency, slice 1 i.e. CellReselectionPrio3,5), F8 (priority to be considered based on the row of highest priority slice supported in the frequency, slice 1 i.e. CellReselectionPrio3,2), F9 (priority to be considered based on the row of legacy priority as no slice is supported i.e. CellReselectionPrio4, 8) are lower priority than F4 based on the above-mentioned priority rules. Further, relative priority between any two frequencies within F1, F2, F3, F4, F5, F6, F7, F8, F9 may also be derived.

In another example, in a case where the cell of frequency F3 doesn't support slice 1. Now there is no slice supported by F3, and UE considers only the legacy priorities for F3. F3 may be prioritized below F1, F2, F4, F5, F6, F7, F8 and below F9. In an embodiment of the present disclosure, the cell has the highest RSRP or highest RSRQ amongst the one or more cells in a frequency.

In another example, when the cell of frequency F1 doesn't support slice 1 but supports slice 2. The UE considers only slice 1 for deriving the relative priority for slice-based cell reselection. In other words, the UE considers any frequency which supports slice 1 as having higher priority than F1 i.e., F1 may be prioritized below F2, F3 and above all other frequencies.

In another embodiment of the present disclosure, the one or more conditions can be implemented using a priority list. A plurality of data structures, such as stack, queue, binary tree, and the like may be used for implementing the one or more conditions.

At step 402, the frequency priority information including the set of frequencies supported by each of the one or more groups of slices and the frequency priority of each of the set of frequencies is received from System Information Blocks (SIB) or dedicated RRC message. In another embodiment of the present disclosure, the frequency priority information including the set of frequencies supported by each slice of the one or more slices and the frequency priority of each of the set of frequencies is received from the SIB or the dedicated RRC message at step 502.

At step 404, the slice priority for each of the one or more groups of slices is received from the network or the internal configuration of the UE 100. In another embodiment of the present disclosure, the slice priority for each slice of the one or more slices is received from the network or the internal configuration of the UE 100.

At step 406, the frequency priority information is sorted based on the slice priority.

At step 408, a m×n priority matrix is created with m slices and n priorities, such that the highest priority slice is at row 1, the next highest priority slice is at row 2 etc. and legacy priority is at row m and equal priority frequencies are at the same cell in the priority matrix. Further, the lowest priority is in column 1 and the highest priority is in column n.

At step 410, it is determined that priority of Frequencym,n is greater than Priority of Frequencya,b if m is greater than a or (m is equal to a and n is greater than b. If m is equal to a and n is equal to b, Frequencym,n and Frequencya,b are of equal priorities.

In an embodiment of the present disclosure, when the UE 100 is in a low coverage area, such that when the measured Srxlev is less than or equal to SnonIntraSearchP and Squal is equal to or less than SnonIntraSearchQ and TreselectionRAT is equal to 0, the UE 100 falls back to using non-slice cell reselection priorities and stops slice-aware cell reselection. In this way, the UE 100 measures all the frequencies for which it has a priority (UE 100 measures low/high/equal priority frequencies at the same time).

In an embodiment of the present disclosure, the UE 100 receives a threshold Snonln-traSearchP and SnonIntraSearchQ from the system information message. The UE 100 also receives cell reselection timer TreselectionRAT from the system information. The thresholds SnonIntraSearchP or SnonIntraSearchQ, and timer TreselectionRAT may be scaled based on mobility status or other parameters.

In an embodiment of the present disclosure, if the measured Srxlev is less than or equal to SnonIntraSearchP and Squal is less than or equal to SnonlntraSearchQ, the UE 100 stops slice-based cell reselection—for e.g., the iterative method mentioned in the background- and directly uses the legacy non-slice-based cell reselection priorities broadcasted or received through dedicated signaling. i.e., the UE 100 detect/measures/evaluates all the frequencies till cell reselection occurs rather than detecting/measuring/evaluating the frequencies supporting one or more slices till the slice-based cell reselection is declared unsuccessful. After falling back to legacy cell reselection, the UE 100 continues to detect/measure/evaluate all the frequencies for cell reselection (i.e., follows legacy cell reselection) even when Srxlev/Squal increases and Srxlev>SnonIntraSearchP and Squal>SnonIntraSearchQ.

In an embodiment of the present disclosure, the UE 100 may check, if the measured Srxlev is less than or equal to SnonTntraSearchP and Squal is less than or equal to SnonIntraSearchQ after performing one or more iterations, and if the condition is satisfied, the UE 100 may directly use the legacy cell reselection without performing further iterations.

In an embodiment of the present disclosure, the UE 100 may also check if the configured value of TreselectionRAT is equal to 0 along with Srxlev is less than or equal to SnonIntraSearchP and Squal is less than or equal to SnonlntraSearchQ, for falling back to legacy cell reselection. If the measured Srxlev is less than or equal to SnonIntraSearchP and Squal is less than or equal to SnonlntraSearchQ and TreselectionRAT is equal to 0, the UE 100 stops slice-based cell reselection—for e.g., the iterative method mentioned in the background and directly uses the legacy non-slice-based cell reselection priorities broadcasted or received through dedicated signaling.

In an alternate embodiment of the present disclosure, the UE 100 receives a different Treselection value, Treselection-slicing from gNB to be used along with slice-based cell reselection. While performing slice-based cell reselection, UE 100 perform the cell reselection if the cell reselection criteria are satisfied for Treselection-slicing seconds.

FIG. 5 illustrates a flow diagram 500 depicting a slice-based priority implementation with the priority matrix, according to an embodiment of the present disclosure. In an embodiment of the present disclosure, the process may include an interaction of slice-based reselection with V2X/MBS/NR side link. If the V2X/MBS/NR side link communication is supported only in one or more frequencies, the UE 100 considers the one or more frequencies as having higher priority than all the one or more slices.

At step 502, slice Information with a list of slices {S1, S2, . . Sn}, a set of frequencies and the frequency priority of each of the set of frequencies are received from the network.

At step 504, the slice priority is received from the network or the internal configuration of the UE 100.

At step 506, a list of frequencies F-service supporting the one or more services are identified.

At step 508, the process may include determining the relative priority of services like V2X/NR-sidelink/MBS with each slice and set the service priority, Pservice. Pservice is greater than the slice priority for a set of slices Sx, equal to the slice priority of a slice-set Sy, less than the slice priority of Slice-set Sz.

At step 510, slice or service prioritization is applied as depicted in FIG. 6.

FIG. 6 illustrates a flow diagram 600 depicting a prioritization of two frequencies with slices and services, according to an embodiment of the present disclosure. As depicted, a process for determining the priority of the frequency A and the frequency B by performing a third set of steps.

At step 602, the slice priority or service priority for each of the one or more groups of slices is determined. Further, at step 602, the frequency priority information for each of the one or more groups of slices is also determined. In another embodiment of the present disclosure, the slice priority or the service priority, and the frequency priority information for each of the one or more slices is determined at step 202. Further, the slice priority or the service priority in a frequency is equal to a priority of the highest priority group of slices or service for the frequency A or 0 if the frequency A is not in the frequency priority information of any slice or no service associated. In an exemplary embodiment of the present disclosure, the frequency priority information includes the set of frequencies supported by each of the one or more groups of slices and the frequency priority of each of the set of frequencies. Furthermore, the frequency priority is equal to a frequency priority from the frequency priority information of the highest priority group of slices or frequency priority of service if it is higher than the priority from the frequency priority information; 0 if there is no frequency priority for the highest priority group of slices or legacy priority if the frequency is not in the frequency priority information of any slice or service.

At step 604, it is determined if the slice priority or the service priority of the frequency A is equal to the slice priority or the service priority of the frequency B. If the slice priority or the service priority of the frequency A is equal to the slice priority or the service priority of the frequency B, step 606 is performed. Further, if the slice priority or the service priority of the frequency A is not equal to the slice priority or the service priority of the frequency B, step 608 is performed.

At step 606, priorities of the frequency A and the frequency B are determined based on the frequency priority information. The priority of the frequency A is higher than the priority of the frequency B if the frequency priority of the frequency A is higher than the frequency priority of the frequency B. Further, the priority of the frequency A is equal to the priority of the frequency B if the frequency priority of the frequency A is equal to the frequency priority of the frequency B. Furthermore, the priority of the frequency A is lower than the priority of the frequency B if the frequency priority of the frequency A is lower than the frequency priority of the frequency B.

At step 608, it is determined if the slice priority or the service priority of the frequency A is higher than the slice priority or the service priority of the frequency B. If the slice priority or the service priority of the frequency A is higher than the slice priority or the service priority of the frequency B, step 610 is performed. Further, if the slice priority or the service priority of the frequency A is lower than the slice priority or the service priority of the frequency B, step 612 is performed.

At step 610, the process may include, it is determined that the frequency A is higher in priority than the frequency B.

At step 612, it is determined that the frequency B is higher in priority than the frequency A.

In an embodiment of the present disclosure, if the UE determines that the priority of a service is higher than the priority of all slices, the UE considers the frequencies supporting the service to be of higher priority than all the frequencies supporting the slices. Further, the UE may skip the slice-based prioritization at step 610, and directly consider the frequencies supporting the services as the highest priority.

FIG. 7 illustrates a flow diagram 700 for repeating the slice-based cell reselection based on the slice update information and the frequency update information, according to an embodiment of the present disclosure. In an embodiment of the present disclosure, the process may include system information change, such as System Information Block 16 (SIB16) used for providing the UE with slice information, the slice update information or the frequency update information or timer expiry for dedicated priority with iteration-based cell reselection. On receiving an indication that the system information broadcasting slice-based priorities has changed, or the UE 100 has received a new version of the slice information, the UE 100 implementing iteration-based cell reselection may restart the slice-based cell reselection even though it is performing legacy cell reselection i.e., the UE 100 starts again with step 1 for the iteration-based technique, as described in the background. The UE 100 may also restart the iteration-based technique when it receives an indication from the NAS that the slice priorities have changed. In another use case, the UE 100 may restart the iteration when slice-based priorities are changed due to a change in the timer associated with the dedicated slice priorities.

At step 702, the slice information with the one or more groups of slices {S1, S2 . . Sn}, the set of frequencies supported by each of the one or more groups of slices and the frequency priority of each of the set of frequencies received from the network.

At step 704, a slice-based cell reselection and fallback to the legacy reselection are performed.

At step 706, the system information change for the slice information, the frequency update information or the slice update information is received from the NAS.

At step 708, the slice-based cell reselection is repeated starting with the highest group of slices.

FIG. 8 illustrates a flow diagram depicting a method for performing slice-based cell reselection, according to an embodiment of the present disclosure. The method 800 as shown in FIG. is implemented in a User Equipment (UE) 100. Further, a detailed description of the method 800 is omitted here for the sake of brevity.

At step 802, the method 800 includes receiving a slice priority from a network for each of one or more groups of slices over a Non-Access Stratum (NAS) or on internal configurations of the UE 100. In an embodiment of the present disclosure, each of the one or more groups of slices includes one or more slices. The slice priority represents the priority of each of the one or more groups of slices.

After the step 802, the method 800 at step 804 includes receiving frequency priority information for each of the one or more groups of slices from the network. In an exemplary embodiment of the present disclosure, the frequency priority information is received from a gNodeB. In an embodiment of the present disclosure, the frequency priority information includes a set of frequencies supported by each of the one or more groups of slices and a frequency priority of each of the set of frequencies.

At step 806, the method 800 includes receiving a set of legacy cell reselection un-associated with the one or more groups of slices for the set of frequencies from the network. In an exemplary embodiment of the present disclosure, the set of legacy cell reselection priorities is received from the gNodeB.

Thus, after receiving the frequency priority information, the method 800 at step 808 includes determining a relative priority for each of the set of frequencies based on the received slice priority, the received frequency priority information, and the received set of legacy cell reselection priorities by using one or more conditions. Relative prioritization of the set of frequencies has been explained in the above paragraphs by using an example with reference to steps 202 to 212 of FIG. 2 and steps 602 to 612 of FIG. 6. As explained in FIG. 2, the slice priority and the frequency priority information associated with frequencies A and B are considered to perform relative prioritization of the frequencies A and B. Further, as explained in FIG. 6, the slice priority, the service priority and the frequency priority information associated with frequencies A and B are considered to perform relative prioritization of the frequencies A and B.

At step 810, the method 800 includes performing slice-based cell reselection based on the determined relative priority. For example, a UE RRC with a slice priority received from NAS or on internal configurations and has received frequency priority for the slices from the network applies slice prioritization.

In determining the relative priority for each of the set of frequencies based on the received slice priority, the received frequency priority information, and the received set of legacy cell reselection priorities by using the one or more conditions, the method 800 includes identifying one or more first frequencies from the set of frequencies supporting one or more highest priority slices based on the received slice priority. The one or more highest priority slices are slices from the one or more groups of slices with the highest slice priority as compared to the slice priority of other slices of among one or more groups of slices. Further, the method 800 includes prioritizing the identified one or more first frequencies over other frequencies of the set of frequencies supporting one or more lower-priority slices. In an embodiment of the present disclosure, the one or more lower priority slices are slices from the one or more groups of slices with lower slice priority as compared to the slice priority of other slices among the one or more groups of slices. Furthermore, the slice-based cell reselection is performed based on a result of prioritization.

Further, in determining the relative priority for each of the set of frequencies based on the received slice priority, the received frequency priority information, and the received set of legacy cell reselection priorities by using the one or more conditions, the method 800 includes identifying one or more frequencies from the set of frequencies supporting a group of slices from the one or more groups of slices. In an embodiment of the present disclosure, the group of slices ranges from the highest priority to the lowest priority. The method 800 includes prioritizing each of the one or more frequencies supporting the group of slices including a group of slices having the highest priority based on the received frequency priority information or the frequency priority of each of the set of frequencies in ascending order. The slice-based cell reselection is performed based on a result of prioritization.

Furthermore, in determining the relative priority for each of the set of frequencies based on the received slice priority, the received frequency priority information, and the received set of legacy cell reselection priorities by using the one or more conditions, the method 800 includes determining if the received frequency priority information for a slice of the group of slices includes a frequency priority for a frequency from the one or more frequencies. The method 800 includes prioritizing the one or more frequencies over the frequency upon determining that the received frequency priority information excludes the frequency priority for the frequency. In an embodiment of the present disclosure, the frequency has a lower priority as compared to the one or more frequencies having the frequency priority for the one or more groups of slices. The slice-based cell reselection is performed based on a result of prioritization.

Further, in determining the relative priority for each of the set of frequencies based on the received slice priority, the received frequency priority information, and the received set of legacy cell reselection priorities by using the one or more conditions, the method 800 includes identifying one or more second frequencies from the set of frequencies un-supporting all of the one or more slices supported by the UE 100. The method 800 includes prioritizing one or more third frequencies from the set of frequencies supporting the one or more slices over the one or more second frequencies.

In an embodiment of the present disclosure, in determining the relative priority for each of the set of frequencies based on the received slice priority, the received frequency priority information, and the received set of legacy cell reselection priorities by using the one or more conditions, the method 800 includes assigning the relative priority to each of the one or more second frequencies that are not supporting any of the one or more slices supported by the UE 100 based on an order of the received set of legacy cell reselection priorities. In an exemplary embodiment of the present disclosure, the set of legacy cell reselection priorities is provided in system information, a Radio Resource Control (RRC) Release message or inherited from another Radio Access Technology (RAT) at inter-RAT cell reselection.

Further, in determining the relative priority for each of the set of frequencies based on the received slice priority, the received frequency priority information, and the received set of legacy cell reselection priorities by using the one or more conditions, the method 800 includes identifying a cell in a frequency from the set of frequencies among one or more cells of in a frequency of the network by comparing Reference Signal Received Power (RSRP) or Reference Signal Received Quality (RSRQ) as configured by the network of each of the one or more cells in the frequency of the network. The cell has the highest RSRP or highest RSRQ amongst the one or more cells in the frequency. Further, the method 800 includes determining if the cell in the frequency supports the one or more highest priority slices from the one or more groups of slices. Furthermore, the method 800 includes prioritizing one or more fourth frequencies from the set of frequencies supporting one or more highest priority slices over the frequency upon determining that the cell in the frequency fails to support the one or more highest priority slices. In an embodiment of the present disclosure, the UE 100 ignores the one or more highest priority slices and considers no slice or the one or more first slices from the one or more groups of slices supported by the cell while performing the slice-based cell reselection. The slice-based cell reselection is performed based on a result of prioritization. Details on performing the slice-based cell reselection based on the slice priority of the cell have been explained in further paragraphs with reference to steps 302 to 306 of FIG. 3. As discussed in FIG. 3, the slice priority of the cell is considered instead of the frequency for the slice-based cell reselection when the cell supports the highest priority slice.

Furthermore, in determining the relative priority for each of the set of frequencies based on the received slice priority, the received frequency priority information, and the received set of legacy cell reselection priorities by using the one or more conditions, the method 800 includes identifying one or more fifth frequencies from the set of frequencies supporting one or more services. In an exemplary embodiment of the present disclosure, the one or more services include Vehicle-to-everything (V2X), New Radio (NR)-sidelink, Multicast and Broadcast Services (MBS), and the like. The method 800 includes prioritizing each of the identified one or more fifth frequencies over one or more third frequencies supporting the one or more slices. The slice-based cell reselection is performed based on a result of prioritization. Details on the one or more services have been explained in the above paragraphs with reference to steps 502-510 of FIG. 5. As explained in FIG. 5, the relative priority of services with each slice is determined for applying the slice prioritization.

In performing the slice-based cell reselection based on the determined relative priority, the method 800 includes creating a priority list, or a priority matrix based on the determined relative priority for each of the set of frequencies. In an embodiment of the present disclosure, each row of the priority matrix corresponds to slice priorities of each of the one or more groups of slices and each column of the priority matrix represents an absolute priority value of the set of frequencies. Further, the method 800 includes performing the slice-based cell reselection based on the created the priority list or the priority matrix. In an embodiment of the present disclosure, the UE 100 considers a highest priority frequency, a cell and one or more highest priority slices based on the created the priority list or the priority matrix for performing the slice-based cell reselection Further, details on the creation of the priority matrix have been explained in above paragraphs with reference to steps 402 to 410 of FIG. 4. As explained in FIG. 4, a priority matrix m*n is created, and the priority evaluation operation is performed based on the created priority matrix.

Further, the method 800 includes receiving slice update information from the network over the NAS. The slice update information corresponds to a change in the slice priority of the one or more groups of slices and dedicated slice priority timeout. Further, the method 800 includes receiving frequency update information from the network. In an embodiment of the present disclosure, the frequency update information corresponds to a change in the set of frequencies supported by each of the one or more slices, the frequency priority of each of the set of frequencies or a combination thereof. Furthermore, the method 800 includes repeating the slice-based cell reselection based on the determined relative priority for each of the set of frequencies, the received slice updated information and the received frequency update information. Details on repeating the slice-based cell reselection have been explained in the above paragraphs with reference to steps 702 to 708 of FIG. 7. As explained in FIG. 7, the slice-based cell reselection is restarted based on the system information change, the frequency update information or the slice update information received from the NAS.

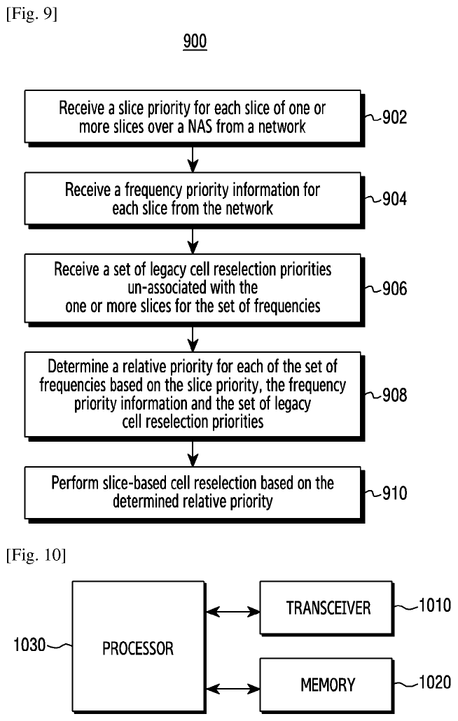

FIG. 9 illustrates a flow diagram depicting a method for performing the slice-based cell reselection, according to another embodiment of the present disclosure. The method 900 as shown in the FIG. is implemented in the UE 100 for performing the slice-based cell reselection. Further, a detailed description of the method 900 is omitted here for the sake of brevity.

At step 902, the method 900 includes receiving the slice priority from the network for each slice of one or more slices over the NAS.

After the step 902, at step 904, the method 900 includes receiving the frequency priority information for each slice from the network. The frequency priority information includes a set of frequencies supported by each slice and a frequency priority of each of the set of frequencies.

At step 906, the method 900 includes receiving the set of legacy cell reselection priorities un-associated with the one or more slices for the set of frequencies from the network.

Thus, after receiving the frequency priority information, at step 908, the method 900 includes determining a relative priority for each of the set of frequencies based on the received slice priority, the received frequency priority information, and the received set of legacy cell reselection priorities by using one or more conditions.

At step 910, the method 900 includes performing slice-based cell reselection based on the determined relative priority. Relative prioritization of the set of frequencies has been explained in the above paragraphs by using an example with reference to steps 202 to 212 of FIG. 2 and steps 602 to 612 of FIG. 6.

In determining the relative priority for each of the set of frequencies based on the received slice priority, the received frequency priority information, and the received set of legacy cell reselection priorities by using the one or more conditions, the method 900 includes identifying one or more first frequencies from the set of frequencies supporting the highest priority slice based on the received slice priority. In an embodiment of the present disclosure, the highest priority slice is a slice from the one or more slices with the highest slice priority as compared to the slice priority of other slices among the one or more slices. Further, the method 900 includes prioritizing the identified one or more first frequencies over other frequencies of the set of frequencies supporting one or more lower-priority slices. In an embodiment of the present disclosure, the one or more lower priority slices are slices from the one or more slices with lower slice priority as compared to the slice priority of other slices among the one or more slices. The slice-based cell reselection is performed based on a result of prioritization.

Further, in determining the relative priority for each of the set of frequencies based on the received slice priority, the received frequency priority information, and the received set of legacy cell reselection priorities by using the one or more conditions, the method 900 includes identifying one or more frequencies from the set of frequencies supporting a slice from the one or more slices. In an embodiment of the present disclosure, the slice ranges from the highest priority to the lowest priority. The method 900 includes prioritizing each of the one or more frequencies supporting the slice based on the received frequency priority information or the frequency priority of each of the set of frequencies in ascending order. The slice-based cell reselection is performed based on a result of prioritization.

Furthermore, in determining the relative priority for each of the set of frequencies based on the received slice priority, the received frequency priority information, and the received set of legacy cell reselection priorities by using the one or more conditions, the method 900 includes determining if the received frequency priority information for the slice includes a frequency priority for a frequency from the one or more frequencies. The method 900 includes prioritizing the one or more frequencies over the frequency upon determining that the received frequency priority information excludes the frequency priority for the frequency. In an embodiment of the present disclosure, the frequency has a lower priority as compared to the one or more frequencies having the frequency priority for the slice. The slice-based cell reselection is performed based on a result of prioritization.

In determining the relative priority for each of the set of frequencies based on the received slice priority, the received frequency priority information, and the received set of legacy cell reselection priorities by using the one or more conditions, the method 900 includes identifying one or more second frequencies from the set of frequencies un-supporting all of the one or more slices supported by the UE 100. Further, the method 900 includes prioritizing one or more third frequencies from the set of frequencies supporting the one or more slices over the one or more second frequencies.

The method 900 includes receiving a set of legacy cell reselection priorities un-associated with the one or more slices for the set of frequencies from the network. Further, the method 900 includes assigning the relative priority to each of the one or more second frequencies that are not supporting any of the one or more slices supported by the UE 100 based on an order of the received set of legacy cell reselection priorities.

In determining the relative priority for each of the set of frequencies based on the received slice priority, the received frequency priority information, and the received set of legacy cell reselection priorities by using the one or more conditions, the method 900 includes identifying a cell in a frequency from the set of frequencies among one or more cells in a frequency of the network by comparing RSRP or RSRQ as configured by the network of each of the one or more cells in the frequency of the network. The cell has the highest RSRP or highest RSRQ amongst the one or more cells in the frequency. Further, the method 900 includes determining if the cell in the frequency supports the highest priority slice from the one or more slices. The method 900 includes prioritizing one or more fourth frequencies from the set of frequencies supporting one or more highest priority slices over the frequency upon determining that the cell in the frequency fails to support the highest priority slice. In an embodiment of the present disclosure, the UE 100 ignores the highest priority slice and considers no slice or the one or more first slices from the one or more slices supported by the cell while performing the slice-based cell reselection. The slice-based cell reselection is performed based on a result of prioritization.

In determining the relative priority for each of the set of frequencies based on the received slice priority, the received frequency priority information, and the received set of legacy cell reselection priorities by using the one or more conditions, the method 900 includes identifying one or more fifth frequencies from the set of frequencies supporting the one or more services. Further, the method 900 includes prioritizing each of the identified one or more fifth frequencies over one or more third frequencies supporting the one or more slices. The slice-based cell reselection is performed based on a result of prioritization.

In performing the slice-based cell reselection based on the determined relative priority, the method 900 includes creating the priority list, or the priority matrix based on the determined relative priority for each of the set of frequencies. Further, the method 900 includes performing the slice-based cell reselection based on the created priority list and the priority matrix. In an embodiment of the present disclosure, the UE 100 considers the highest priority frequency, a cell and the highest priority slice based on the created priority list or the priority matrix for performing the slice-based cell reselection.

In an embodiment of the present disclosure, the method 900 includes receiving slice update information from the network over the NAS. The slice update information corresponds to a change in the slice priority of the one or more slices and dedicated slice priority timeout. Further, the method 900 includes receiving frequency update information from the network. The frequency update information corresponds to a change in the set of frequencies supported by each of the one or more slices, the frequency priority of each of the set of frequencies or a combination thereof. Furthermore, the method 900 includes repeating the slice-based cell reselection based on the determined relative priority for each of the set of frequencies, the received slice updated information and the received frequency update information.

FIG. 10 illustrates a block diagram of a base station, according to embodiments of the present disclosure.

As shown in FIG. 10 is, the base station of the present disclosure may include a transceiver 1010, a memory 1020, and a processor (or, a controller) 1030. The transceiver 1010, the memory 1020, and the processor (or controller) 1030 of the base station may operate according to a communication method of the base station described above. However, the components of the base station are not limited thereto. For example, the base station may include more or fewer components than those described in FIG. 10. In addition, the processor (or controller) 1030, the transceiver 1010, and the memory 1020 may be implemented as a single chip. Also, the processor (or controller) 1030 may include at least one processor.

The transceiver 1010 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor (or controller) 1030, a signal through a wireless channel, and transmit a signal output from the processor (or controller) 1030 through the wireless channel.

The memory 1020 may store a program and data required for operations of the base station. Also, the memory 1020 may store control information or data included in a signal obtained by the base station. The memory 1020 may be a storage medium, such as ROM, RAM, a hard disk, a CD-ROM, and a DVD, or a combination of storage media.

The processor (or controller) 1030 may control a series of processes such that the base station operates as described above. For example, the processor (or controller) 1030 may receive a data signal and/or a control signal, and the processor (or controller) 1030 may determine a result of receiving the signal transmitted by the terminal and/or the core network function.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The present invention provides the following advantages:
1) The present invention considers the network slice priority, the frequency priority and the set of legacy cell re-selection priorities at any instant for all the frequencies while performing the slice-based cell reselection. The UE considering any one type of priority at a time leads to the UE camping on non-optimal frequencies. For example, there could be multiple frequencies supporting a slice and some of the frequencies may have lesser bandwidth and thereby offering lesser performance. If the UE considers only slice priority and reselects to a frequency without considering the frequency priority at any instant, the UE may reselect to a frequency with lower performance. Additionally, if the UE doesn't measure all frequencies considering all the priorities, such as slice priority, frequency priority and legacy cell reselection priority, but measures only certain frequencies which are configured with one or two of all the priorities, it can lead to delays in cell reselection. Further, the UE performs cell reselection when the cell reselection evaluation is satisfied for the Treselection duration. Hence during network fluctuations, the cell reselection delay may be much higher unless all the priorities are considered together. The cell reselection delay may also lead to cell reselection failures.
2) The present invention prioritizes whether the slices are important, or the one or more services are important.
3) The present invention considers the slice update information and the frequency update information for repeating the slice-based cell reselection.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method performed by a user equipment (UE) in a wireless communication system, the method comprising:
obtaining first information including a slice priority for at least one group of slices, wherein the at least one group of slices includes at least one slice;
receiving, from a base station, second information including a group cell reselection priority for each of the at least one group of slices,
wherein the group cell reselection priority associated with a priority of at least one group frequency that supports each of the at least one group of slices;
receiving, from the base station, third information including a cell reselection priority for at least one frequency that supports none of the at least one group;
identifying the reselection priority for the at least one group of slices and the at least one frequency based on the first information, the second information, and the third information; and
performing slice-based cell reselection based on the identified priority.

2. The method of claim 1, wherein the identifying of the reselection priority further comprises:
prioritizing the at least one highest group frequency for a highest slice priority for at least one group of slices based on the slice priority.

3. The method of claim 2, wherein the identifying of the reselection priority further comprises:
in case that a slice priority for the at least one highest group frequency is same, prioritizing the at least one highest group frequency based on a highest group cell reselection priority.

4. The method of claim 3, wherein the identifying of the reselection priority further comprises:
in case that the group cell reselection priority is not given for a group of slices at a frequency, prioritizing the frequency has a lowest priority.

5. The method of claim 1, wherein the identifying of the reselection priority further comprises:
prioritizing the at least one group frequency higher than the at least one frequency, and
prioritizing the at least one frequency based on the cell reselection priority.

6. The method of claim 1, wherein the identifying of the reselection priority further comprises:
in case that a cell in a frequency supports highest ranked cell and does not support the group at least one group of slices, re-identifying the reselection priority for the frequency.

7. The method of claim 1, further comprising:
receiving, from the network entity, fourth information including a changed slice priority for the at least one group of slices;
re-identifying the reselection priority based on the fourth information.

8. The method of claim 1,
wherein the first information is provided by non access stratum (NAS),
wherein the second information is provided in at least of system information or dedicated signalling, and
wherein the third information is provided in at least of the system information or the dedicated signalling.

9. A user equipment (UE) in a wireless communication system, the UE comprising:
a transceiver; and
at least one processor coupled with the transceiver and configured to:
obtain first information including a slice priority for at least one group of slices, wherein the at least one group of slices includes at least one slice,
receive, from a base station, second information including a group cell reselection priority for each of the at least one group of slices, wherein the group cell reselection priority associated with a priority of at least one group frequency that supports each of the at least one group of slices,
receive, from the base station, third information including a cell reselection priority for at least one frequency that supports none of the at least one group,
identify the reselection priority for the at least one group of slices and the at least one frequency based on the first information, the second information, and the third information, and
perform slice-based cell reselection based on the identified priority.

10. The UE of claim 9, wherein, in order to the identifying of the reselection priority, at least one processor is further configured to:
prioritize the at least one highest group frequency for a highest slice priority for at least one group of slices based on the slice priority.

11. The UE of claim 10, wherein, in order to the identifying of the reselection priority, at least one processor is further configured to:
in case that a slice priority for the at least one highest group frequency is same, prioritize the at least one highest group frequency based on a highest group cell reselection priority.

12. The UE of claim 11, wherein, in order to the identifying of the reselection priority, at least one processor is further configured to:
in case that the group cell reselection priority is not given for a group of slices at a frequency, prioritize the frequency has a lowest priority.

13. The UE of claim 9, wherein, in order to the identifying of the reselection priority, at least one processor is further configured to:
prioritize the at least one group frequency higher than the at least one frequency, and
prioritize the at least one frequency based on the cell reselection priority.

14. The UE of claim 9, at least one processor is further configured to:
receive, from the network entity, fourth information including a changed slice priority for the at least one group of slices;
re-identify the reselection priority based on the fourth information.

15. The UE of claim 9,
wherein the first information is provided by non access stratum (NAS),
wherein the second information is provided in at least of system information or dedicated signalling, and
wherein the third information is provided in at least of the system information or the dedicated signalling.
